(19) United States
(12) Patent Application Publication
(10) Pub. No.: US 2019/0002307 A1
(43) Pub. Date: Jan. 3, 2019

(54) A Protein Separation Structure

(71) Applicant: ShenZhen Honya Aquarium Equipments Manufacturer Co., Ltd., Guangdong (CN)

(72) Inventor: Xiaojun ZHANG, Guangdong (CN)

(21) Appl. No.: 15/741,295

(22) PCT Filed: Aug. 8, 2017
(86) PCT No.: PCT/CN2017/096388

§ 371 Date: Jan. 2, 2018

(30) Foreign Application Priority Data
Mar. 3, 2017 (CN) 201720219872

(51) Int. Cl. C02F 1/24

(52) U.S. Cl. CPC C02F 1/24; C02F 2101/38

(57) ABSTRACT

The embodiment of the utility model discloses a protein separation structure, comprising a reaction chamber and a waste liquid collection cup connected to the upper end of the reaction chamber, wherein a water pump and a compression chamber connected with the water pump are provided in the described reaction chamber, and the bottom of the described compression chamber is provided with a spiral channel, and the top of the compression chamber is provided with a sieve plate, and the described sieve plate is provided with the spiral sieve hole that has the same rotating direction as the spiral channel, and the water body is pumped to the compression chamber through the spiral passage by the described pump; The water body impinges the sieve plate to spray towards the reaction chamber through the spiral sieve hole. The utility model has the beneficial effects as follows: a protein separation structure provided by the utility model has the advantages of high foaming efficiency, remarkable purification effect, and effective integration of the muffling device into the protein separation device body, additionally, improving the accuracy of water level control and grasping the quality of water purification.

### BACKGROUND OF THE INVENTION

The utility model involves a water purification device, in particular to a protein separation structure.

Although the existing protein separator can meet the function of protein separation to achieve the purpose of purifying water, but the performance is not satisfactory in many places, for example, the foaming performance is relatively weak, and the purification effect is not remarkable, and the noise produced in the process of use is large, and the external muffler is used to affect the overall coordination of the device. In addition, the water level is mostly regulated by water valve, so that the control accuracy is not high. Based on the present situation, it is necessary to propose an improved protein separation structure.

### BRIEF SUMMARY OF THE INVENTION

The utility model aims at overcoming the shortcomings of the existing technology, providing a protein separation structure with high foaming efficiency and remarkable purification effect, and effectively integrating the muffling device into the protein separation device body. In addition, it can improve the accuracy of water level control, d grasp the quality of water purification.

In order to solve above technical problem, the embodiment of the utility model provides a protein separation structure, the improvement of which comprises a reaction chamber and a waste liquid collection cup connected to the upper end of the reaction chamber, and the described reaction chamber is provided with a water pump and a compression chamber connected with the pump, and the bottom of the described compression chamber is provided with a spiral passage, and the top of the compression chamber is provided with a sieve plate, and the described sieve plate is provided with the same spiral sieve hole as the spiral channel, and the water body is pumped through the spiral passage to the compression chamber by the pump; The water body impinges the described sieve plate to spray into the reaction chamber through the spiral sieve hole.

In above structure, the inlet end of the pump is connected with the inlet disposed outside the reaction chamber, the radial side wall of the inlet is provided with an air inlet connected with the inlet, and the pump pumps water through the inlet. The negative pressure generated at the inlet is mixed with air from the inlet into the water body.

In above structure, the described waste liquid collection cup and the reaction chamber are connected by a annular muffler, which is provided with an air inlet, an outlet and a muffling channel, and the described air inlet and the described air outlet are connected to each other through a muffling channel inside the annular muffler, and one end of the described air outlet exposed to the annular muffler is connected with the described air inlet through the intake pipe.

In above structure, one side of the reaction chamber is provided with a water level regulator connected with the bottom of the reaction chamber, and the described water level regulator comprises an outlet pipe, which is provided with a regulating rod, and the bottom of the described regulating rod is connected with a plug attached to the inner wall of the outlet pipe, and the top of the described regulating rod is meshed with a knob through a rack, and a rotary knob meshing the transmission rack, and the plug at the bottom of the regulating rod moves up and down the outlet pipe to regulate the discharge rate of the outlet.

The above structure also comprises a quick removal structure for fixing the bottom plate of the reaction chamber to the mounting plate.

In above structure, the quick removal structure is a bolt regulating hole provided on the bottom plate, and the bolt is fixed to the mounting plate through the screw regulating hole, which rotates the bottom plate relative to the mounting plate, and the bolt slips along the bolt regulating hole, and the bolt regulating hole has at least one place for the larger end of the bolt to pass through.

In above structure, the quick removal structure comprises a rotating tongue which can rotate around a bolt, and the lower end of the described rotating tongue is provided with a tooth mouth for the bottom plate to buckle in, and the rotating tongue is mounted on the fixed plate through a bolt.

In above structure, the quick removal structure comprises a push block with a bolt regulating hole, and the bolt is connected on the mounting plate through the bolt regulating hole, and the push block is pushed along the bolt regulating hole, and the pressing plate on the side of the push block is pressed to the upper surface of the bottom plate, and lock the bolt and fix the bottom plate to the mounting plate.

In above structure, the quick removal structure includes a fixing block fixed on the mounting plate by bolts and a movable block connected with the fixing block, and the bolt of the described movable block penetrates the side end of the fixing block, and the bottom plate is pressed on the mounting plate.

In above structure, the described movable block is provided with a pinch plate at the side end of the bolt, and when the pin is connected with the fixed block, there is a gap between the pinch plate and the fixing block.

The embodiment of the utility model has the following beneficial effects:

In the embodiment of the utility model, the utility model provides a protein separation structure, which has the advantages of high foaming efficiency, remarkable purification effect, and effective integration of the muffling device in the body of the protein separation device, additionally, improving the accuracy of water level control, and grasping the quality of water purification.

### BRIEF DESCRIPTION OF THE DRAWINGS

FIG. 1 is a stereoscopic diagram of a protein separation structure in the embodiment of the utility model.

FIG. 2 is an internal structure diagram of a protein separation structure in the embodiment of the utility model.

FIG. 3 is a schematic diagram of the inner structure of the annular muffler in the embodiment of the utility model.

FIG. 4 is a schematic diagram of a compression chamber structure and its connection to a water pump in the embodiment of the utility model.

FIG. 5 is a schematic diagram of a protein separation structure in the embodiment of the utility model.

FIG. 6 is a schematic diagram of the quick removal structure in the embodiment of the utility model.

In the figure: 1. Waste liquid collection cup; 2. Annular muffler; 3. Reaction chamber; 4. Intake pipe; 5. Intake; 6. Water level regulator; 7. Water pump; 8. Sieve plate; 9. Compression chamber; 10. Water inlet pipe of compression chamber; 11. Mounting plate; 12. Rotating tongue; 13. Pushing block; 14. Fixed block; 15. Movable block; 21. Air inlet; 22. Air outlet; 23. Muffling channel; 31. Bottom plate; 41. Air intake; 61. Water outlet pipe; 62. Regulating rod; 63. Knob; 64. Plug; 81. Spiral sieve hole; 91. Spiral channel; 611. Water outlet; 621. Rack; 121. Teeth mouth; 131. Bolt regulating hole; 132. Press plate; 151. Pin; 152. Pinch plate

### DETAILED DESCRIPTION OF THE INVENTION

The utility model is further described below in combination with the attached drawings and specific embodiments:

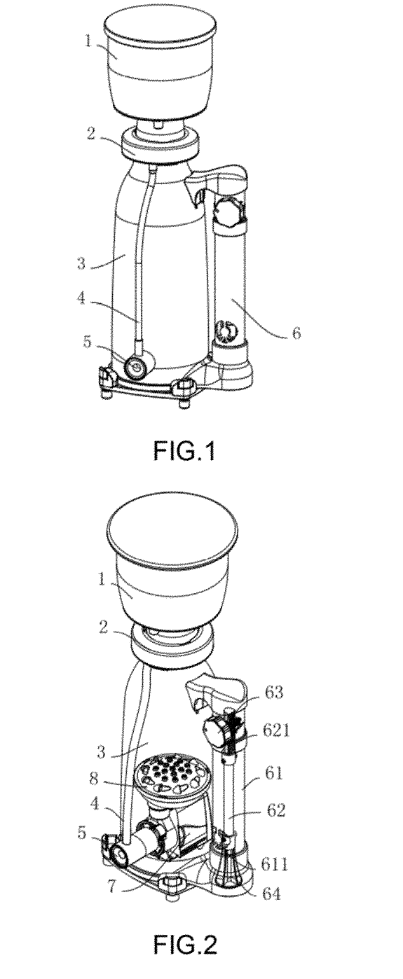

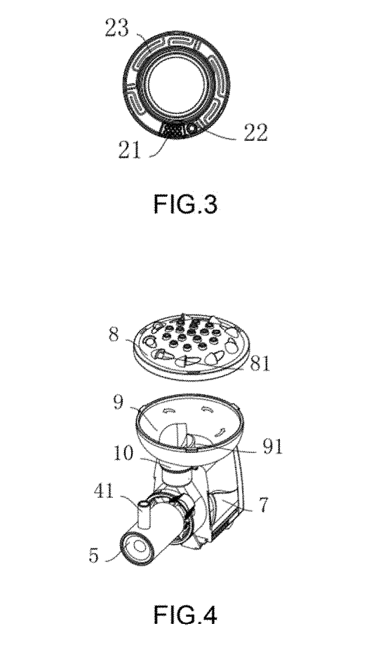

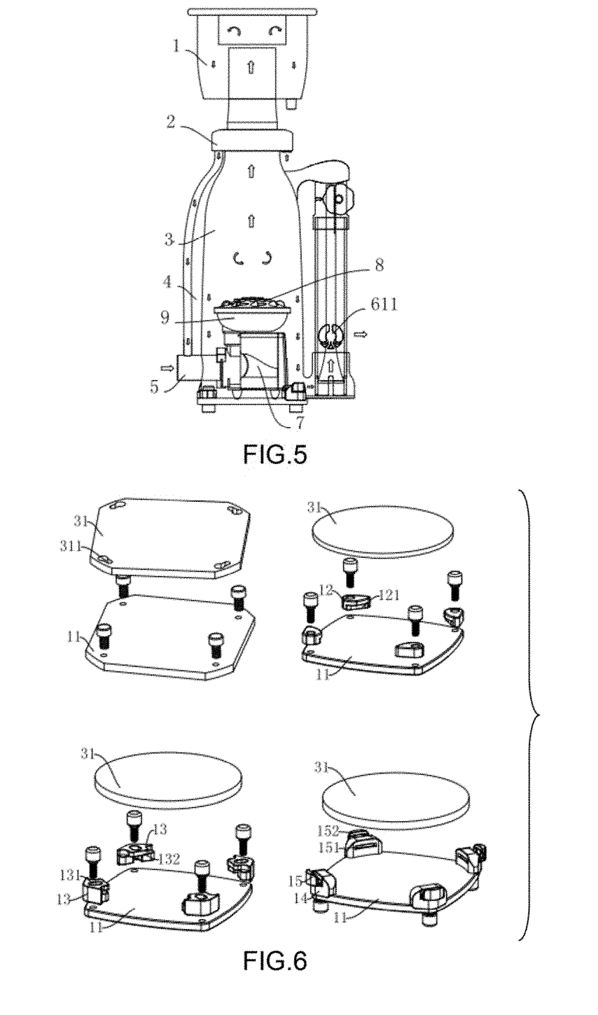

Referring to FIGS. 1 to 6, the utility model discloses a protein separation structure comprising a reaction chamber 3 and a waste liquid collection cup 1 attached to the upper end of the reaction chamber 3, and the reaction chamber 3 is provided with a pump 7 and a compression chamber 9 connected with the water pump 7, specifically, the compression chamber 9 can be connected with the water outlet of the pump 7 through water inlet pipe 10 of the compression chamber; The bottom of the compression chamber 9 is provided with a spiral channel 91, and the top of the compression chamber 9 is provided with a sieve plate 8, and the sieve plate 8 is provided with the same spiral sieve hole 81 as the spiral channel 91, and the water pump 7 pumps the water body to the compression chamber 9 through the spiral passage 91; The water body impacts the sieve plate 8 and spray towards the reaction chamber 3 through the spiral sieve hole 81, and this spiral impact mode can stimulate the production of bubbles in the water, and then improve the efficiency of bubble making, and the purification effect is remarkable, and the spiral method can rotate the water body at high speed and make centrifugal motion, which produces much higher kinetic energy than the direct spray, and the amount of foam produced directly affects the adsorption effect of protein in the water body.

Further, the water inlet end of the pump 7 is connected with the water inlet 5 provided outside the reaction chamber 3, and the radial side wall of the water inlet 5 is provided with an air inlet 41 connected with the water inlet 5, when the pump 7 is pumping water through the water inlet 5, the negative pressure generated at the water inlet 5 is mixed into the water body by extracting air from the air inlet 41, meanwhile, the generated negative pressure is used to pump the air into the water body and pump towards the compression chamber 9, and the amount of bubbles produced is significantly larger, and this setting does not require a special device to inject gas into the foaming process.

Further, the waste liquid collection cup 1 is connected with the reaction chamber 3 through a annular muffler 2, which is provided with an air inlet hole 21, an air outlet 22 and a muffling channel 23, and the air inlet hole 21 and the air outlet 22 are connected with each other through the muffling channel 23 inside the annular muffler 2, and one end of the air outlet 22 exposed from the annular muffler 2 is connected with the air inlet 41 through the air intake pipe 4, and the integrated design of noise suppression in the connection component saves the space occupied by the device and has a good overall feeling, in order to avoid the sudden bad effect of the muffling device which is set independently outside the device.

Further, one side of the reaction chamber 3 is provided with a water level regulator connected to the bottom of the reaction chamber 3, comprising an outlet pipe 61 with an outlet 611, and the outlet pipe 61 is built-in with a regulating rod 62, and the bottom of the regulating rod 62 is connected with a plug 64 attached to the inner wall of the outlet pipe 61, and the top of the regulating rod 62 is meshed with a knob 63 through the rack 621, and the rotating knob 63 meshes the rack 621, and the plug 64 at the bottom of the regulating rod 62 moves up and down along the water outlet pipe 61 to regulate the discharge rate of the water outlet 611, and the meshing between the knob 63 and the rack 621 can effectively control the displacement of the upper and lower movement of the plug 64, and then the plugging of 611 water outlet is realized, and the control precision is directly derived from the gap between teeth of rack 621, which is easy to control and has high precision of water level regulation.

Further, a quick removable structure where the bottom plate 31 of the reaction chamber 3 is attached to the mounting plate 11 is also included, which effectively improves the installation and removal efficiency of the device.

Further, the quick removal structure is a bolt regulating hole 131 provided on the bottom plate 31, and the bolt is fixed to the mounting plate 11 through the screw regulating hole, and the bottom plate 31 is rotated relative to the mounting plate 11, and the bolt slips along the bolt regulating hole 131, which has at least one place for the larger end of the bolt to pass through, so that the bottom plate 31 can be fixed to the mounting plate 11 only by loosening or tightening the bolt, and the difficulty of aligning the hole position can be reduced by the bolt regulating hole position 131 while mounting

Further, the quick removal structure includes a rotating tongue 12 that rotates around a bolt, and a lower end of the rotating tongue 12 is provided with a tooth mouth 121 for the bottom plate 31 to buckle in, and a rotating tongue 12 is mounted on the fixing plate through a bolt, and the rotary locking mode can be flexibly applied when the base size is not fixed, and the height of the tooth mouth 121 can be regulated according to the actual needs, and the tooth mouth 121 may press the base against the fixing plate when the rotating tongue 12 turns and attaches against the base when it is attached to the base.

Further, the quick removal structure includes a push block 13 provided with a bolt regulating hole 131, and the bolt is connected to the mounting plate 11 through the bolt regulating hole 131, in order to drive the push block 13 along the bolt regulating hole 131, and the press plate 132 on the side end of the push block 13 is pressed against the upper surface of the bottom plate 31, and the bolt is locked, and the bottom plate 31 is fixed on the mounting plate 11.

Further, the quick removal structure includes a fixing block 14 bolted to the mounting plate 11 and a movable block 15 connected to the fixing block 14, which penetrates the side end of the fixing block 14 by the pin 151 of the movable block 15, and the bottom plate 31 is pressed on the mounting plate 11.

Further, a pinch plate 152 is provided on the side end of the pin 151 on the movable block 15, and when the pin 151 is connected to the fixing block 14, there is a gap between the pinch plate 152 and the fixing block 14, so that it is convenient to enable the pinch plate 152, and detach the pin 151 of the movable block 15 from the fixed block 14, and then the device can be removed and the use is extremely simple.

The above-mentioned illustration is only a preferred one for the present utility model but not a limitation on the present utility model. All kinds of transformations and modifications can be made within the scope of technological thoughts of this utility model. All embellishments, modifications or equivalent replacements by ordinary technicians in this field base on the above description are within the scope of protection for this utility model.

What is claimed is:

1. A protein separation structure is characterized in that it comprises a reaction chamber and a waste liquid collection cup connected to the upper end of the reaction chamber, wherein a water pump and a compression chamber connected with the water pump are provided in the described reaction chamber, and the bottom of the described compression chamber is provided with a spiral channel, and the top of the compression chamber is provided with a sieve plate, and the described sieve plate is provided with the spiral sieve hole that has the same rotating direction as the spiral channel, and the water body is pumped to the compression chamber through the spiral passage by the described pump; The water body impinges the sieve plate to spray towards the reaction chamber through the spiral sieve hole.

2. According to a protein separation structure described in claim 1, it is characterized in that the water inlet end of the described pump is connected with the water inlet outside the reaction chamber, and the radial side wall of the water inlet is provided with an air inlet connected with the water inlet, and when the described pump pumps water through the inlet, the negative pressure generated at the inlet is mixed with air from the inlet into the water body.

3. According to a protein separation structure described in claim 2, it is characterized in that the waste collection cup and the reaction chamber are connected by a annular muffler, and the annular muffler is provided with an air intake hole, an air outlet and a muffling channel, and the described inlet air hole and the described air outlet are connected mutually through the muffling channel inside the annular muffler, and one end of the air outlet exposed from the annular muffler is connected with the water inlet through the intake pipe.

4. According to a protein separation structure described in each of claims 1-3, it is characterized in that a water level regulator connected to the bottom of the reaction chamber is provided on one side of the described reaction chamber, and the described water level regulator comprises an outlet pipe provided with an water outlet, and the described water outlet pipe is provided with a regulating rod, and a plug attached to the inner wall of the outlet pipe is connected at the bottom of the described regulating rod, and the top of the described regulating rod is meshed with a knob through a rack, and the rotary knob meshes the transmission rack, and the regulating rod drives the plug at the bottom of the regulating rod to move up and down along the water outlet pipe to regulate the discharge rate of the water outlet.

5. According to a protein separation structure described in claim 4, it is characterized in that it also includes a quick removal structure in which the bottom plate of the reaction chamber is fixed to the mounting plate.

6. According to a protein separation structure described in claim 5, it is characterized in that the described quick removal structure is a bolt regulating hole provided on the bottom plate, and the bolt passes through the spiral regulating hole and fixes the mounting plate, and relative to the mounting plate rotating the bottom plate, the bolt slips along the bolt regulating hole, and the bolt regulating hole has at least one place for the larger end of the bolt to pass through.

7. According to a protein separation structure described in claim 5, it is characterized in that the described quick removal structure comprises a rotating tongue which can rotate around a bolt, and the lower end of the described rotating tongue is provided with a tooth mouth for the bottom plate to buckle in, and the described rotating tongue is mounted on the fixing plate through a bolt.

8. According to a protein separation structure described in claim 5, it is characterized in that the described quick removal structure comprises a push block provided with a bolt regulating hole, which is connected to the mounting plate through the bolt regulating hole, and the push block is pushed along the bolt regulating hole, in order to press the pressing plate on the side of the push block onto the upper surface of the bottom plate, and lock the bolt, and fix the bottom plate on the mounting plate.

9. According to a protein separation structure described in claim 5, it is characterized in that the described quick removal structure comprises a fixed block fixed by bolt on the mounting plate and a movable block plugged into the fixed block, and a pin of the described movable block penetrates the side end of the fixing block and presses the bottom plate on the mounting plate.

10. According to a protein separation structure described in claim 9, it is characterized in that the described movable block is provided with a pinch plate at the side end of the described pin, when the pin is connected with the fixed block, there is a gap between the pinch plate and the fixing block.
